(19) United States
(12) Patent Application Publication
(10) Pub. No.: US 2006/0055350 A1
(43) Pub. Date: Mar. 16, 2006

(54) Complex type temperature control circuit for a cooling fan

(76) Inventors: Ho-Wen Lin, Taipei (TW); Meng-Chic Lin, Taipei (TW)

Correspondence Address: G. LINK CO., LTD.;PMB 174, Suite 137, 931 West 75th Street, Naperville, IL, 60565, US

(21) Appl. No.: 10/938,610

(22) Filed: Sep. 13, 2004

(51) Int. Cl. G05B 5/00

(52) U.S. Cl. 318/268; 318/471

(57) ABSTRACT

A complex type temperature control circuit for a cooling fan includes two or more resistance series sets. The first resistance series set is a resistor connecting in series with a temperature sensing member. The second resistance series set is a resistor connecting in series with a temperature sensing member too. Further, the second resistance series set is connected in parallel to the temperature sensing member of the first resistance series set. Hence, the complex type temperature control circuit can make a voltage change rate resulting from temperature change increases such that a range of fan rotational speed change can be increased under the same temperature change.

### BACKGROUND OF THE INVENTION

1. Field of the Invention

The present invention is related to a complex type temperature control circuit for a cooling fan and particularly to a circuit, which provides two or more resistance series sets in series with each of the resistance series sets having a resistor and a temperature sensing member and the second resistance series set being connected to the temperature sensing member of the first resistance series, for a voltage change rate resulting from temperature change being increased with a range of fan rotational speed being increased under the same temperature change too.

2. Brief Description of the Related Art

Referring to FIG. 1, a conventional temperature control circuit for a cooling fan provides a thermistor 112 being connected in series to a resistor 111 with a constant voltage Vcc being applied to the circuit. Due to the thermistor 112 being capable of changing resistance value thereof corresponding to temperature change, it leads to output voltage Vout thereof changing with respect to the temperature. Further, magnitude of output voltage Vout, which is a divided voltage obtained via the resistor 111 and the thermistor 112, is related to characteristics of the thermistor 112.

Different temperature changes result in constant gradient change of the divided output voltage Vout.

Referring to FIG. 2, two thermistors 112 are connected in parallel to each other and then connected in series to the resistor 111 so that the divided output voltage Vout can vary corresponding resistance value of the thermistors 112. But, the resistance value of therrnisters 112 in parallel can be replaced by the resistance value of single thermistor 112 in the preceding conventional circuit.

Referring to FIG. 3, two thermistors 112 are connected in series to each other and then connected to the resistor 111 in series so that the divided output voltage Vout can change corresponding resistance value of the thermistors 112. But, the resistance value of series thermisters 112 can be replaced by the resistance value of single thermistor 112 in the preceding conventional circuit.

Referring to FIG. 4 in company with FIGS. 1 to 3, when temperature changes from T1 to T2, the slope change lines “b”, “c” of the output voltage Vout obtained via a dividing circuit regardless the thermistors 112 being connected in parallel or in series before being connected in series to the resistor 111 and the slope change line “a” of the output voltage Vout in case of a thermistor 112 being connected to a resistor 111 are a specific value respectively and the characteristics thereof is related to the characteristics of the thermistors 112 after being connected in series or parallel. Because the gradient change of the respective conventional circuit is a constant value, it is unable to increase range of the output voltage Vout change such that the fan rotational speed change being incapable of increased under the same temperature change.

### SUMMARY OF THE INVENTION

A primary object of the present invention is to provide a complex temperature control circuit for a cooling fan, which provides at least two resistance series sets and each of the resistance series sets is a resistor being connected in series a temperature sensing member with one of the resistance series sets is further connected in parallel to the temperature sensing member of the other one of the resistance series sets, such that the voltage change rate resulting from temperature change can be increased and range of fan rotational speed change can be increase too.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a temperature control circuit diagram illustrating the first type conventional cooling fan;

FIG. 2 is a temperature control circuit diagram illustrating the second type conventional cooling fan;

FIG. 3 is a temperature control circuit diagram of the third type conventional cooling fan;

FIG. 4 is a slant line diagram illustrating temperature changes of the first type to the third type conventional cooling fans with respect to output voltages;

FIG. 5 is a temperature control circuit diagram of a cooling fan according to the present invention in the first embodiment thereof,

FIG. 6 is a slant line diagram illustrating temperature changes of the first embodiment according to the present invention and the first type conventional cooling fan with respect to output voltages;

FIG. 7 is a temperature control circuit diagram of a cooling fan according to the present invention in the second embodiment thereof;

FIG. 8 is a slant line diagram illustrating temperature changes of the first and second embodiments according to the present invention and the first type conventional cooling fan with respect to output voltages;

FIG. 9 is a temperature control circuit diagram of a cooling fan according to the present invention in the third embodiment thereof; and

FIG. 10 a slant line diagram illustrating temperature changes of the first, second and third embodiments according to the present invention and the first type conventional cooling fan with respect to output voltages.

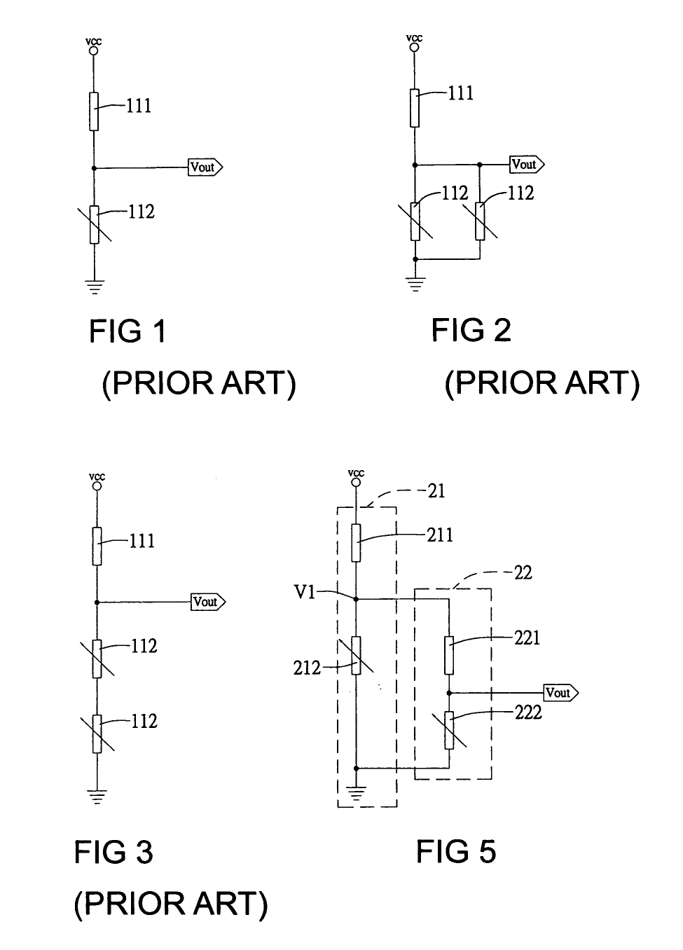

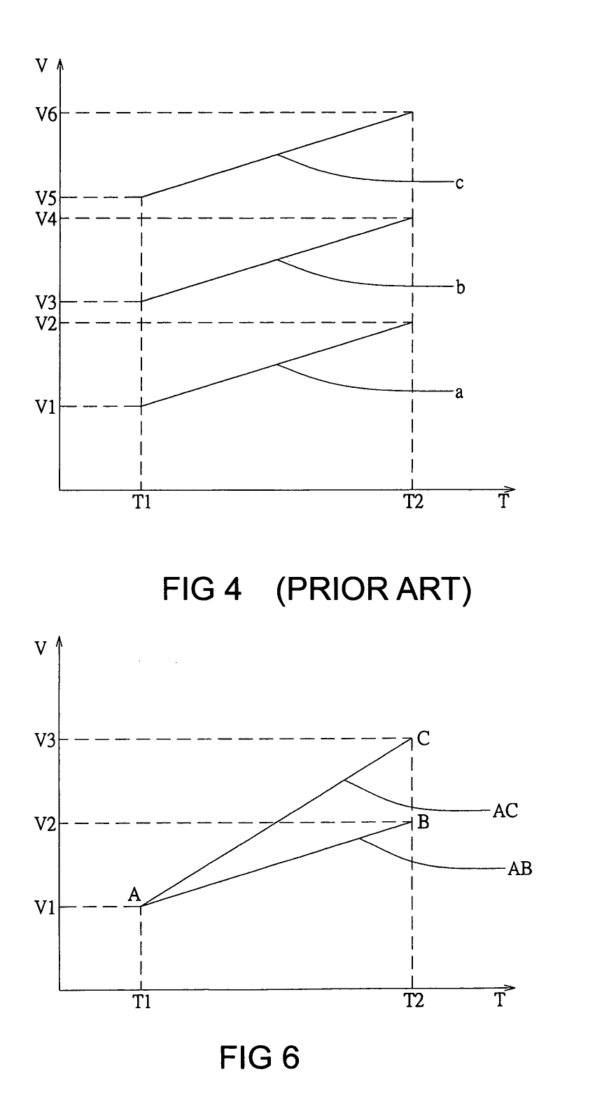

### DETAILED DESCRIPTION OF THE INVENTION

Referring to FIG. 5, a complex type temperature control circuit of a cooling fan according to the present invention in the first embodiment thereof provides a first resistance series set 21, which has a first resistor 211 being connected in series to a first temperature sensing member 212, a second resistance series set 22, which has a second resistor 221 being connected in series to a second temperature sensing member 222. Further, the second resistance series set 22 is connected in parallel to the first temperature sensing member 212 and the first and second sensing members 212, 222 are thermistors.

Once a constant voltage Vcc is applied to the first resistor series set 21, a voltage drop V1 is formed after passing through the first resistor 211 to offer the second resistor series set 22. Taking advantage of the first and the second temperature sensing members 212, 222 having a feature of providing different resistances under different temperatures, the voltage drop V1 is divided and formed an output voltage Vout via both the second resistor 221 and the second temperature sensing member 222 to control fan rotational speed.

Referring to FIG. 6, Once temperature changes from T1 to T2 and the voltage output Vout is obtained from the preceding circuit, the output voltage Vout corresponding to the temperature gradient moves to V3 from V1 instead of originally being to V2. The gradient change of the voltage is from a slant line AB resulting from conventional point A to point B moving to a slant line AC resulting from point A to point C. Increase of gradient also means voltage change rate generated from increasing temperature change and, meanwhile, it leads range of fan rotational speed change increases under the same temperature change.

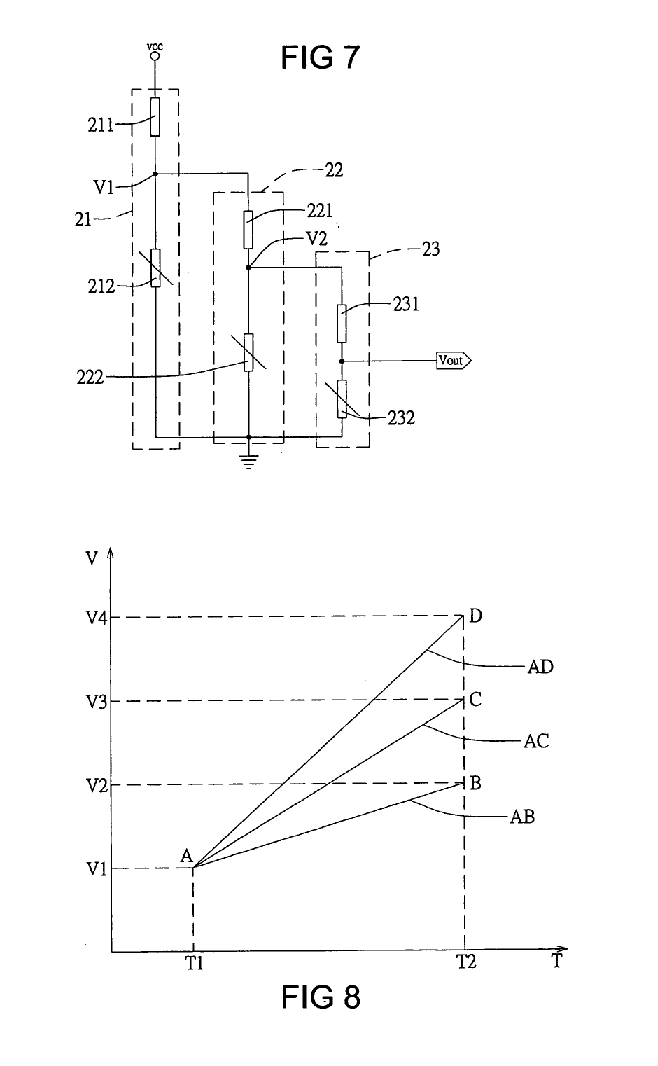

Referring to FIG. 7, the second embodiment of the present embodiment is illustrated. The operation concept of the second embodiment is similar to the first embodiment. The difference of the second embodiment from the first embodiment is the second temperature sensing member 222 is connected in parallel to both the third resistor 231 and the third sensing member 232 of a third resistance series set. The first, second and third temperature sensing members 212, 222, 232 are thermistors. Once a constant voltage Vcc is applied to the first resistance series set 21, a voltage drop V1 is formed after passing through the first resistor 211 to offer the second resistor series 22. The voltage drop V1 is divided and formed a second reference voltage V2 and the second reference voltage V2 is divided and formed the output voltage Vout via both the third resistor 231 and the third temperature sensing member 232 to control fan rotational speed.

Referring to FIG. 8, once temperature changes from T1 to T2 and the voltage output Vout is obtained from the preceding circuit, the output voltage Vout corresponding to the temperature change moves to V4 from V1 instead of originally moving to V3 from V1. The gradient change of the voltage is from a slant line AC formed of point A to point C moving to a slant line AD formed of point A to point D. Increase of gradient also means voltage change rate generated from change of increasing temperature and, meanwhile, it leads range of fan rotational speed change increasing under the same temperature change.

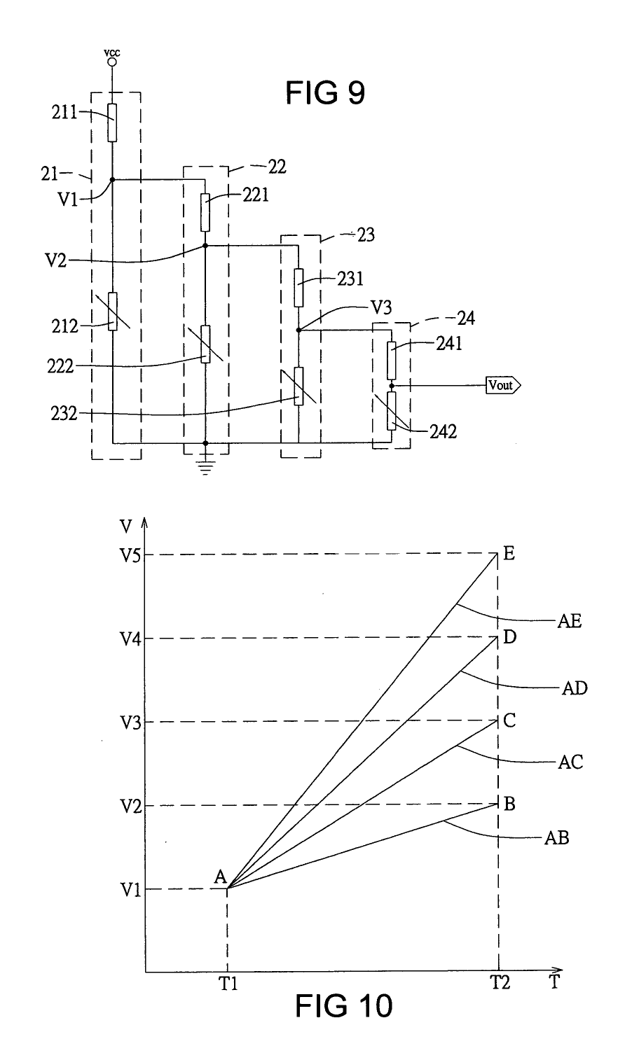

Referring to FIGS. 9 and 10, it can be learned from the preceding two embodiments that at least two first temperature sensing members 212 of the first resistance series set 21 can be connected in parallel to the second resistance series set 22 and the second temperature sensing member 222 of the second resistor series 22 can be connected to the third resistance series set 23. Further, the third temperature sensing member 232 of the third resistance series set 23 can be connected in parallel to the fourth resistor 241 and the fourth temperature sensing member 242 of the fourth resistance series set 24. Consequently, the change of output voltage Vout can be moved to V5 from V1 instead of moving to V4 from V1 and the gradient of change moves to slant line AE from slant line AD. By the same token, multiple set of resistance series can be connected in parallel to each other as well such that the change rate of the output voltage Vout resulting from the temperature change can increase with respect to gradient increase of the temperature change and, accordingly, the range of fan rotational speed change can increase under the same temperature change.

While the invention has been described with referencing to preferred embodiments thereof it is to be understood that modifications or variations may be easily made without departing from the spirit of this invention, which is defined by the appended claims.

1-11. (canceled)

12. A complex type temperature control circuit for a cooling fan, comprising:
a primary resistor series set, providing a first resistor connecting with a first thermistor in series and producing an initial voltage after the first resistor; and
a secondary resistance series set, providing a second resistor connecting with a second thermistor in series, connecting with the primary resistor series set;
characterized in that the first thermistor connects with the secondary resistance series set in parallel and an output voltage of the second resistance series set changes corresponding to an ambient temperature change such that a slope formed between the initial voltage and the output voltage is higher than that done by the conventional circuits described in the application.

13. The complex type temperature control circuit for a cooling fan as defined in claim 12, wherein at least a third resistance series set is provided to connect with the secondary resistance series in a way of the second thermistor being connected to the third resistance series set in parallel.

14. The complex type temperature control circuit for a cooling fan as defined in claim 13, wherein the third resistance series set has a third resistor connecting with a third thermistor in series.
